(19) United States
(12) Patent Application Publication
(10) Pub. No.: US 2021/0048061 A1
(43) Pub. Date: Feb. 18, 2021

(54) SUCTION CUP HOLDER AND METHOD OF SUCTIONING AND POSITIONING MOBILE PRODUCT

(71) Applicant: Shenzhen Annaijia Electronics Co., Ltd., Shenzhen City (CN)

(72) Inventor: Weizhao Yang, Shenzhen City (CN)

(21) Appl. No.: 16/576,775

(22) Filed: Sep. 20, 2019

(30) Foreign Application Priority Data
Aug. 16, 2019 (CN) 201910759242.1

(51) Int. Cl. F16B 47/00; H04B 1/3888

(52) U.S. Cl. CPC F16B 47/00; H04B 1/3888

(57) ABSTRACT

A suction cup holder and a method of suctioning and positioning a mobile product are disclosed. The suction cup holder includes a suction cup and a mounting portion for mounting the suction cup. The suction cup has a disk body and a deformable suction panel disposed on one side of the disk body. The suction cup is moveable relative to the mounting portion. The deformable suction panel is deformable relative to the disk body. Thus, the deformable suction panel is linked to be deformed and returned by movement of the suction cup. The structure is simple, the controllability is good, and the utility is strong.

### BACKGROUND OF THE INVENTION

### 1. Field of the Invention

The present invention relates to a holder, and more particularly to a suction cup holder and a method of suctioning and positioning a mobile product, which is mainly used for suctioning and positioning mobile electronic products such as mobile phones, but not limited thereto.

### 2. Description of the Prior Art

Nowadays, there are three types of suction cup holders on the market.

The first is to control the pressure through an air pump to control the gas in the space between the mobile phone and the holder, so that the mobile phone can be suctioned and positioned to or separated from the holder. This structure has complicated structure, poor controllability, etc.

The second is to control the opening and closing of an air hole. When the mobile phone is placed in the holder, the holder is manually pressed to form a vacuum chamber for suctioning and positioning the mobile phone. When the mobile phone needs to be taken out, the air hole is opened and the gas flows into the vacuum chamber, so that the mobile phone can be detached from the holder. The operation is troublesome.

The third is to provide an elastic self-locking switch. When the mobile phone is placed, the mobile phone is pressed against the suction cup surface to create vacuum suction between the mobile phone and the suction cup surface, so that the mobile phone is suctioned and positioned on the suction cup surface. When the mobile phone needs to be taken out, the mobile phone is gently pressed against the suction cup surface to unlock the self-locking switch, and the vacuum suction between the mobile phone and the suction cup surface disappears, so that the mobile phone can be taken out. The structure is complicated, the operation is troublesome, and the controllability is not good.

Accordingly, the inventor of the present invention has devoted himself based on his many years of practical experiences to solve these problems.

### SUMMARY OF THE INVENTION

In view of the drawbacks of the prior art, the primary object of the present invention is to provide a suction cup holder and a method of suctioning and positioning a mobile product, having the advantages of simple structure, good controllability and practicality.

Another object of the present invention is to provide a suction cup holder and a method of suctioning and positioning a mobile product, which can skillfully use the mobile product's own gravity to drive a suction cup to slide down. In the process of sliding down, a deformable suction panel is deformed to suction the mobile product tightly. Since the gravity always exists, it can ensure that the mobile product is suctioned and positioned by the suction cup tightly.

In order to achieve the above objects, the present invention adopts the following technical solutions:

According to one aspect of the present invention, a suction cup holder is provided. The suction cup holder comprises a suction cup and a mounting portion for mounting the suction cup. The suction cup has a disk body and a deformable suction panel disposed on one side of the disk body. The suction cup is moveable relative to the mounting portion. The deformable suction panel is deformable relative to the disk body. When the suction cup is moved from a first position to a second position relative to the mounting portion, the deformable suction panel is linked to be deformed inward to increase the volume of a space between a mobile product and the deformable suction panel to form a negative pressure. When the suction cup is moved from the second position to the first position relative to the mounting portion, the deformable suction panel is linked to be returned outward to reduce the volume of the space between the mobile product and the deformable suction panel.

According to another aspect of the present invention, a method of suctioning and positioning a mobile product is provided. The method comprises: when the mobile product is placed, a suction cup being moved from a first position to a second position and a deformable suction panel being linked to be deformed inward to increase the volume of a space between the mobile product and the deformable suction panel to form a negative pressure; when the mobile product is taken out, the suction cup being moved from the second position to the first position and the deformable suction panel is linked to be returned outward to reduce the volume of the space between the mobile product and the deformable suction panel.

Compared with the prior art, the present invention has obvious advantages and beneficial effects. Specifically, it can be known from the above technical solutions that the suction cup is movably disposed relative to the mounting portion, and the deformable suction panel is linked to be deformed inward or returned outward when the suction cup is moved relative to the mounting portion. This method has a simpler mechanical structure, which is beneficial for reducing the cost of the suction cup holder, and can be better promoted and applied to benefit the users. When placing or taking a mobile product (such as a mobile phone, etc.), the suction cup is moved by means of the mobile product's gravity, which is easy to operate, practical, and controllable.

### BRIEF DESCRIPTION OF THE DRAWINGS

FIG. 1 is a perspective view according to a first embodiment of the present invention;

FIG. 2 is a front view according to the first embodiment of the present invention;

FIG. 3 is a sectional view taken along line A-A of FIG. 2;

FIG. 4 is a sectional view taken along line B-B of FIG. 2;

FIG. 5 is an exploded view according to the first embodiment of the present invention;

FIG. 6 is a front view according to a second embodiment of the present invention;

FIG. 7 is a rear perspective view according to the second embodiment of the present invention;

FIG. 8 is a sectional view according to the second embodiment of the present invention;

FIG. 9 is a front perspective view according to a third embodiment of the present invention;

FIG. 10 is an exploded view according to the third embodiment of the present invention;

FIG. 11 is a sectional view according to the third embodiment of the present invention;

FIG. 12 is a sectional view according to a fourth embodiment of the present invention;

FIG. 13 is a side view according to a fifth embodiment of the present invention;

FIG. 14 is a partial view according to a sixth embodiment of the present invention;

FIG. 15 is a schematic view according to the sixth embodiment of the present invention when used in an oblique manner;

FIG. 16 is a partial view according to a seventh embodiment of the present invention;

FIG. 17 is a sectional view according to the seventh embodiment of the present invention;

FIG. 18 is a partial view according to an eighth embodiment of the present invention; and

FIGS. 19-22 are schematic views of the present invention applied with a force in different directions.

### DETAILED DESCRIPTION OF THE PREFERRED EMBODIMENTS

Embodiments of the present invention will now be described, by way of example only, with reference to the accompanying drawings.

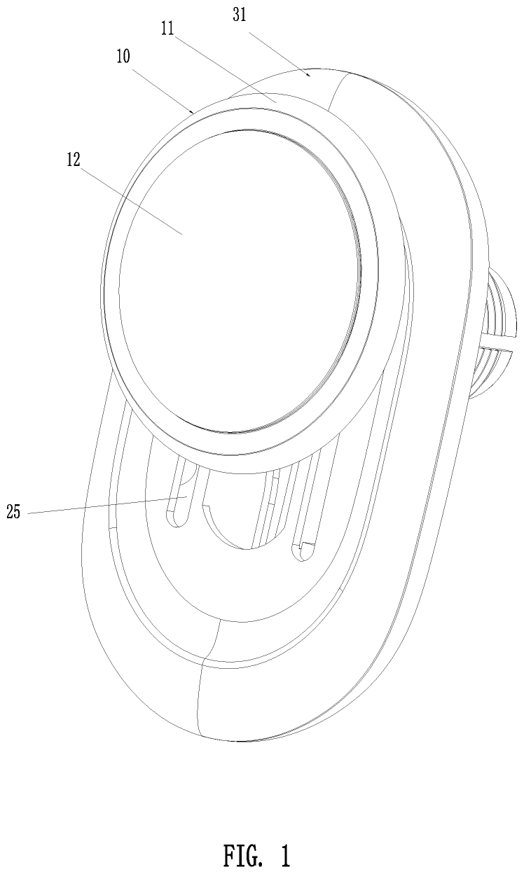

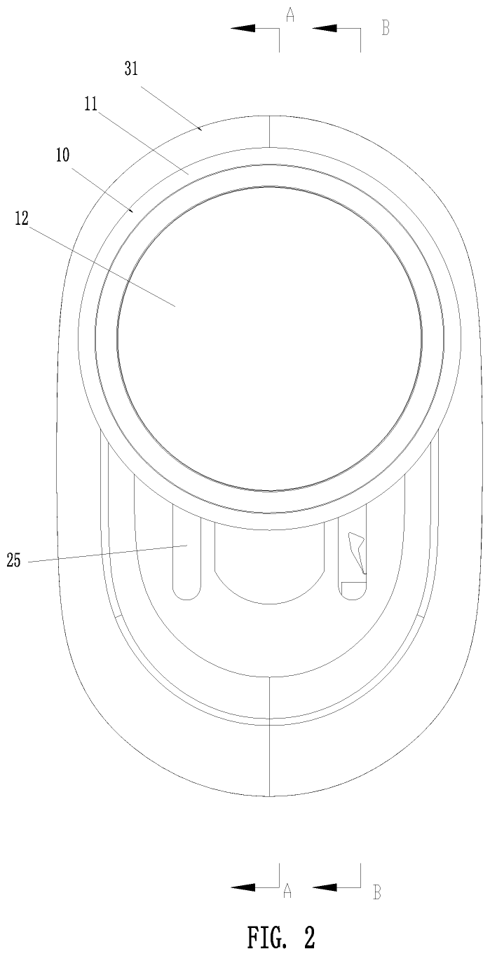

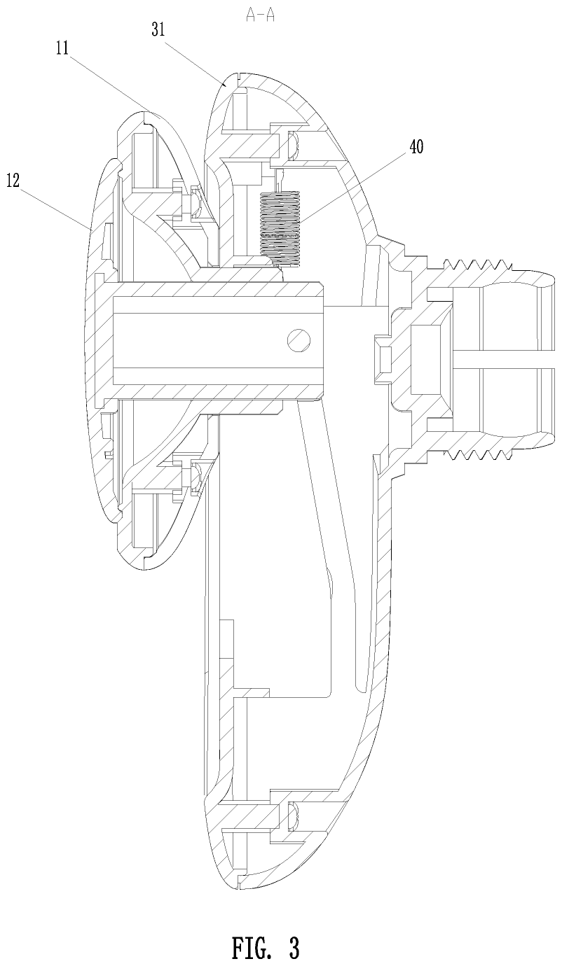

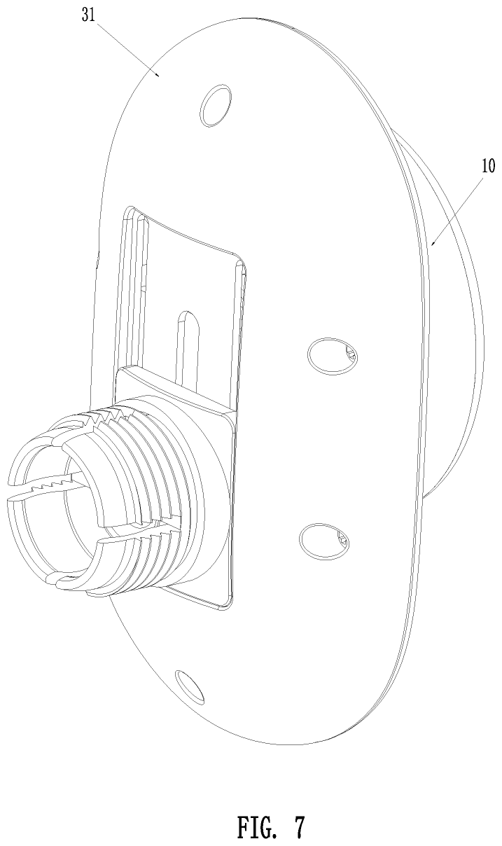

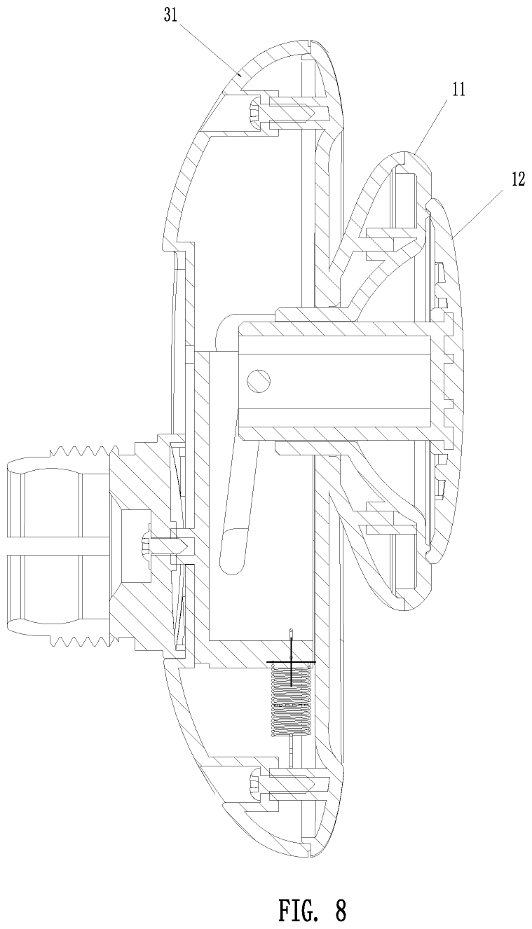

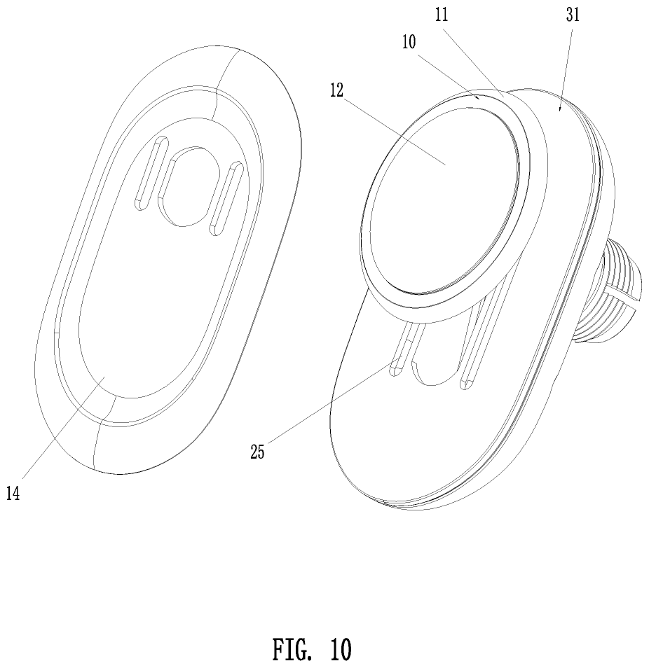

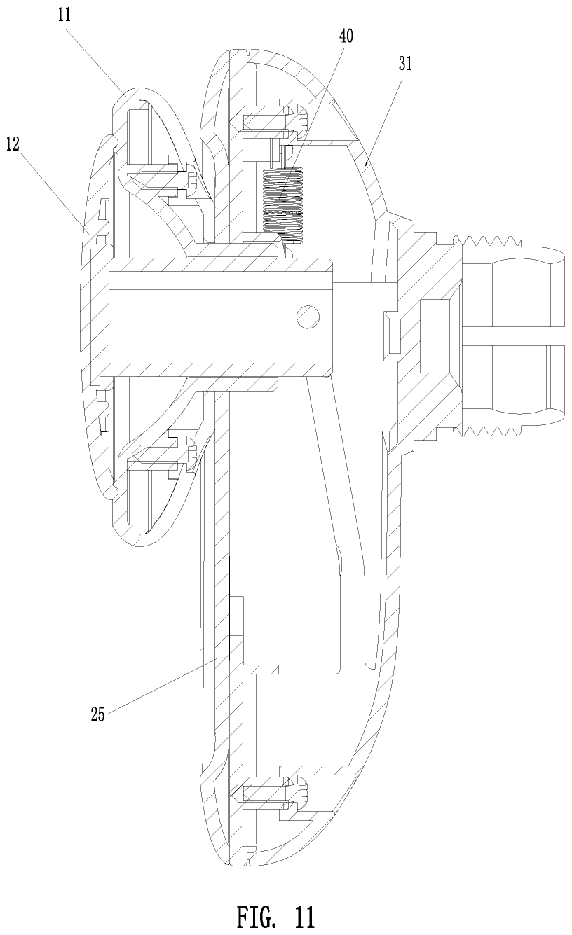

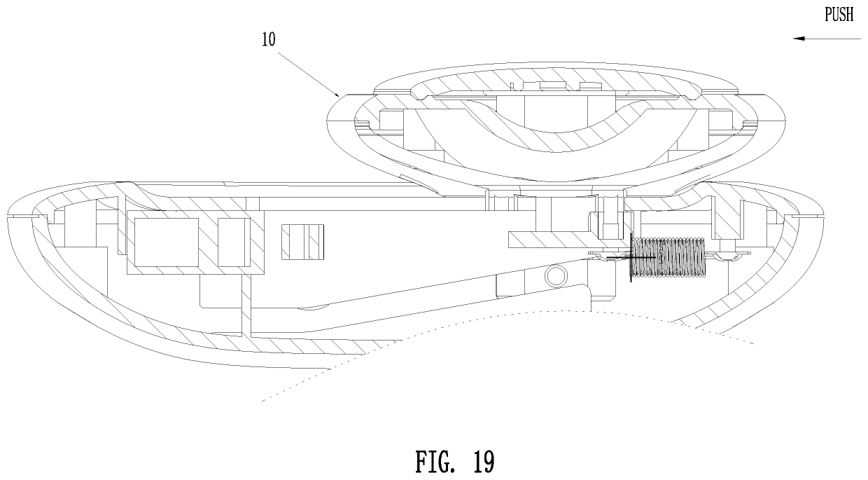

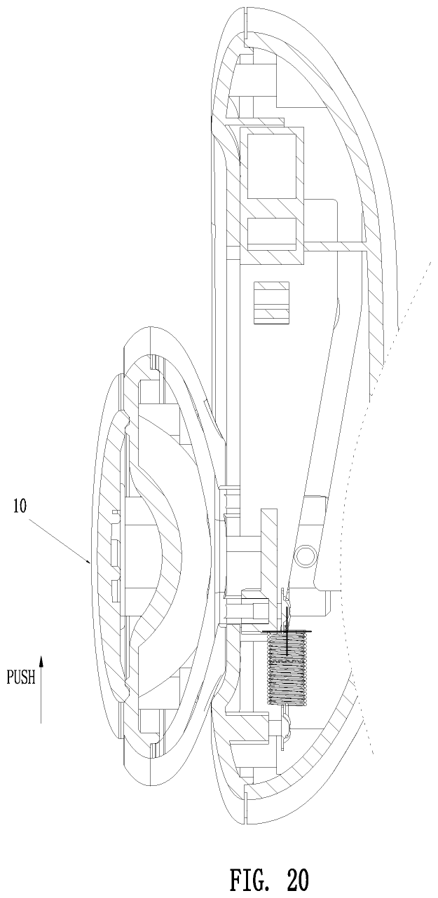

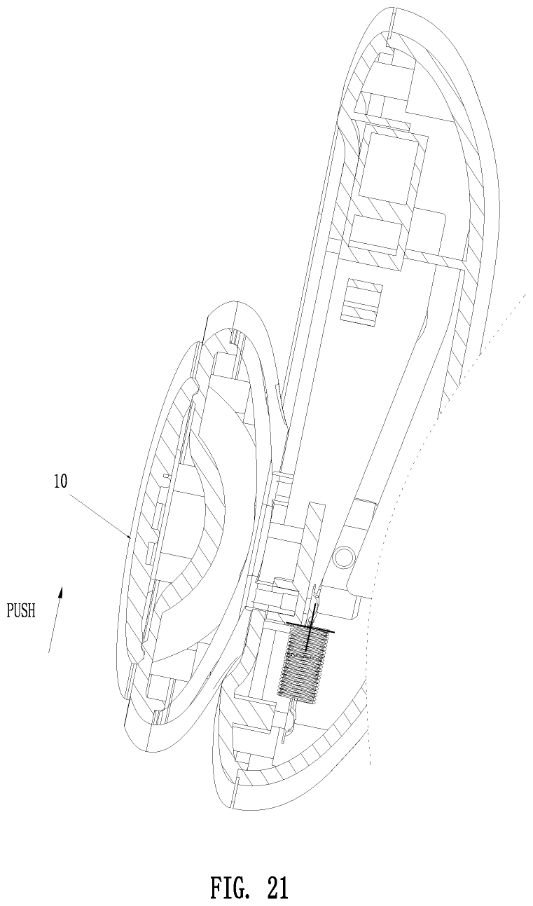

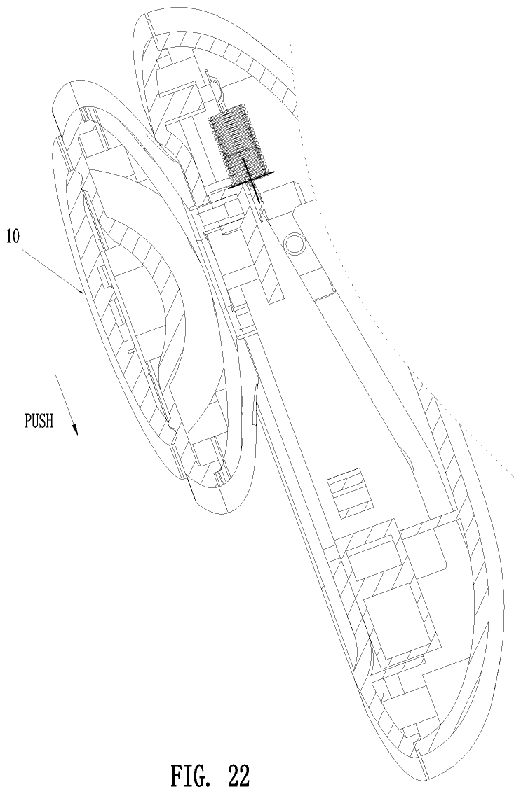

FIGS. 1 to 22 illustrate the specific structures of various embodiments of the suction cup holder of the present invention. The suction cup holder is used for suctioning and positioning mobile electronic products, such as mobile phones, and it may be used for suctioning other products having a relatively flat and smooth surface to be suctioned.

The suction cup holder comprises a suction cup 10 and a mounting portion for mounting the suction cup 10. The suction cup 10 has a disk body 11 and a deformable suction panel 12 disposed on one side of the disk body 11. The suction cup 10 is moveable relative to the mounting portion. The deformable suction panel 12 is deformable relative to the disk body 11. When the suction cup 10 is moved from a first position to a second position relative to the mounting portion, the deformable suction panel 12 is linked to be deformed inward to increase the volume of a space between a mobile product and the deformable suction panel 12 to form a negative pressure. When the suction cup 10 is moved from the second position to the first position relative to the mounting portion, the deformable suction panel 12 is linked to be returned outward to reduce the volume of the space between the mobile product and the deformable suction panel 12. When the suction cup 10 is moved up and down, the deformable suction panel 12 is linked. The linking structure may be various linking structures, but not limited thereto. The suction cup 10 may be disposed laterally or vertically or obliquely. Thus, the direction of movement of the suction cup 10 also changes accordingly.

Preferably, the deformable suction panel 12 is disposed on the front side of the disk body 11. The suction cup 10 is moved up and down relative to the mounting portion. The deformable suction panel 12 is deformed back and forth relative to the disk body 11. When the suction cup 10 is moved downward, the deformable suction panel 12 is linked to be deformed backward to increase the volume of the space between the mobile product and the deformable suction panel 12 to form the negative pressure. When the suction cup 10 is moved upward, the deformable suction panel 12 is linked to be returned forward to reduce the volume of the space between the mobile product and the deformable suction panel 12. When the disk body 11 is moved, the entire suction cup 10 is driven to move. A linking structure is provided between the disk body 11 and the deformable suction panel 12, so that the deformable suction panel 12 is linked by the linking structure to be deformed or returned when the disk body 10 is moved.

A method of suctioning and positioning a mobile product comprises: when the mobile product is placed, a suction cup 10 being moved from a first position to a second position and a deformable suction panel 12 being linked to be deformed inward to increase the volume of a space between the mobile product and the deformable suction panel to form a negative pressure; when the mobile product is taken out, the suction cup 10 being moved from the second position to the first position and the deformable suction panel 12 is linked to be returned outward to reduce the volume of the space between the mobile product and the deformable suction panel.

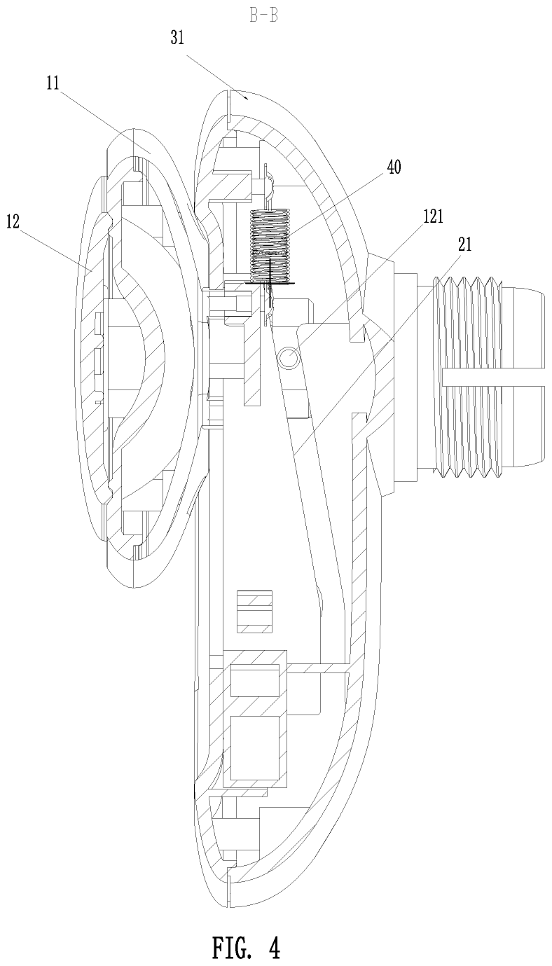

As shown in FIG. 4 and FIGS. 19 to 22, several implementations are shown. When the suction cup 10 is arranged in different directions, if an external force is exerted to push the suction cup, the direction of push is also different. Therefore, in the actual design, the suction cup 10 can be changed in various specific applications. The push manners and directions and the details won't be described hereinafter.

Preferably, when the mobile product is placed, a downward force is exerted on the suction cup 10 so that the suction cup 10 is moved downward, and the deformable suction panel 12 on the suction cup 10 is linked to be deformed backward to increase the volume of the space between the mobile product and the deformable suction panel 12 to form the negative pressure, and the mobile product is suctioned on the front side of the suction cup 10. The downward force acting on the suction cup 10 comes from the mobile product's own gravity or a press force when the mobile product is placed or the sum of the mobile product's own gravity and the press force when the product is placed. Generally, the placement surface on the suction cup 10 for the mobile product to be placed leans slightly backward. Automatic suction may be achieved only by the mobile product's own gravity. Of course, a certain press force may be exerted when the mobile product is placed. Through the mobile product's own gravity and the press force when placing the mobile product, the mobile product can be suctioned tightly. If the placement surface on the suction cup 10 for the mobile product to be placed is arranged vertically or leans slightly forward, at the initial moment, the mobile product is pre-suctioned on the deformable suction panel 12 by the press force at the time of placing the mobile product, and then the mobile product is suctioned tightly by the sum of the mobile product's own gravity and the press force when the product is placed.

When the mobile product is taken out, the suction cup 10 is moved upward by an upward force, and the deformable suction panel 12 on the suction cup 10 is linked to be returned forward to reduce the volume of the space between the mobile product and the deformable suction panel 12 and increase the pressure of the space so that the mobile product can be taken out. The upward force comes from a first resultant force after a return force of a return device of the suction cup 10 is offset by the mobile product's gravity or a second resultant force of the first resultant force and an upward push or the upward push.

Next, the specific implementation structure of the suction cup holder will be further described with reference to the accompanying drawings.

As shown in FIGS. 1 to 5, a first exemplary implementation of the linking structure for the suction cup 10 to link the deformable suction panel 12 is shown.

The mounting portion has a linking surface 21 extending vertically. The linking surface 21 extends from top to bottom and leans backward, or the linking surface 21 extends from the top to the bottom and curves backward. The deformable suction panel 12 is connected to a first action portion 121. The first action portion 121 is confined by the rear side of the linking surface 21 and is selectively moved up and down along the linking surface 21. Preferably, a groove surrounded by the rear side of the linking surface 21 is configured to receive the first action portion 121, which facilitates the positioning and movement of the first action portion 121.

When the suction cup 10 is moved downward, the first action portion 21 is moved downward along the linking surface 21 to pull the deformable suction panel 12 to be deformed backward. When the suction cup 10 is moved upward, the first acting portion 121 is moved upward along the linking surface 21 to gradually release the deformable suction panel 12 to be returned forward.

In the first embodiment, the mounting portion has a housing 31 and a mounting body. The housing 31 generally includes a front housing and a rear housing that are assembled to each other. The rear housing is connected to the mounting body. The mounting body may be a collet, a universal joint, a suction cup mount, etc. The collet may be an air vent clip. The universal joint may be a ball joint. The suction cup mount directly uses a suction cup at its rear side to achieve the installation and positioning of the entire suction cup holder. The suction cup 10 is mounted on the front side of the housing 31. The housing 31 is mounted on the mounting body. Therefore, the suction cup 10 can be moved up and down relative to the housing 31.

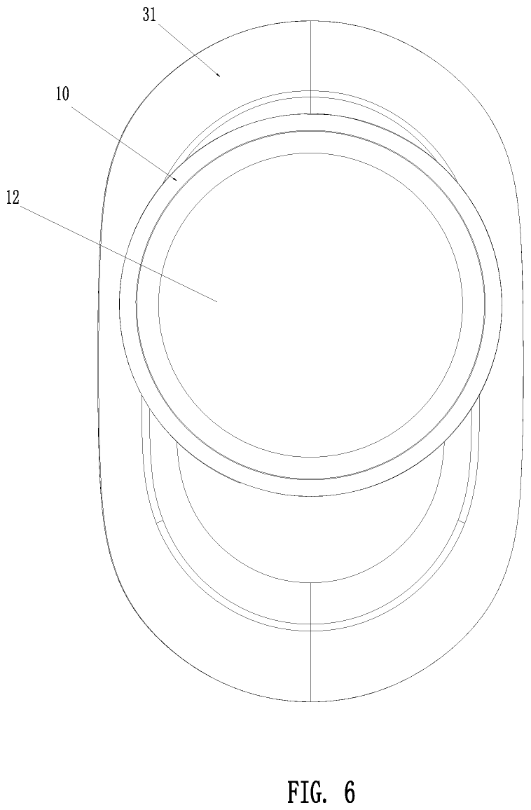

As shown in FIGS. 6 to 8, the suction cup 10 and the housing 31 are moved up and down together relative to the mounting body. The linking surface 21 is formed on the mounting body.

In the first embodiment, the mounting portion is provided with a guide groove 25 extending vertically. The suction cup 10 has a guide block 13. The guide block 13 is slidably disposed in the guide groove 25. In the first embodiment, the guide groove 25 is exposed.

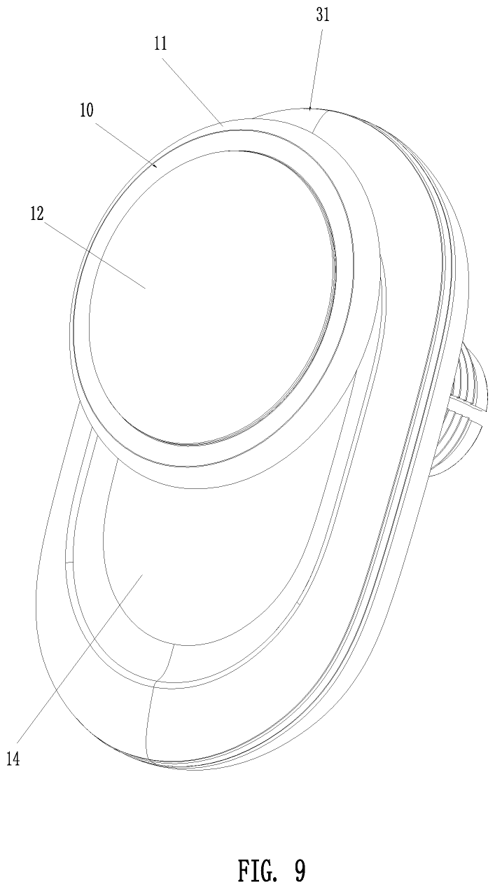

As shown in FIGS. 9 to 11, a shielding plate 14 is disposed on the front side of the guide groove 25. The shielding plate 14 is connected to the suction cup 10 to be moved up and down along with the suction cup 10 relative to the mounting portion. Through the arrangement of the shielding plate 14, on the one hand, the front side of the suction cup 10 presents more pleasing to the eyes, and on the other hand, the guide groove 25 is shielded to prevent dust and the like from entering the inside of the holder, thereby improving the stability of the performance of the holder and prolonging the service life of the holder.

In the first embodiment, the present invention further comprises a return device. The return device acts between the suction cup 10 and the mounting portion. The return device automatically returns the suction cup 10 upward when the mobile product is taken out to offset part or all of the weight of the mobile product. Of course, the return device may be not provided. When the mobile product needs to be taken out, the suction cup is manually pushed up to return it back to the initial state. In the first embodiment, the return device is an elastic return device, which uses a spring 40, a tension spring, a torsion spring or an elastic rubber to provide a return elastic force. When the suction cup 10 is moved downward, the elastic return device is deformed to store the elastic potential energy. When the mobile product is taken out to offset part or all of the weight of the mobile product, the suction cup 10 is automatically returned upward under the elastic force.

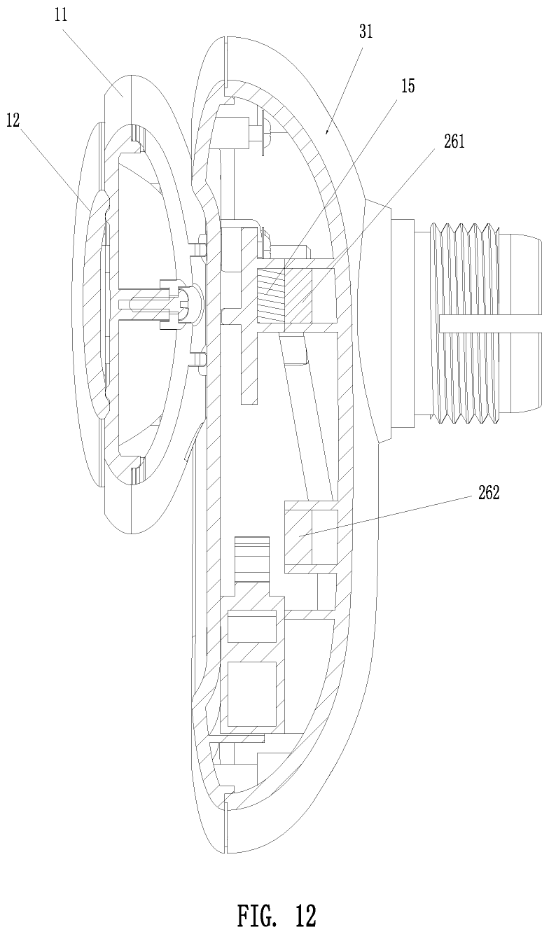

As shown in FIG. 12, the return device may be a magnetic return device. The initial state is that the magnetic force holds the suction cup 10. When the mobile product is placed into the holder, the mobile product's own gravity or the mobile product's own gravity and the external force will act on the suction cup 10 to be moved downward. When the mobile product is taken out to offset part or all of the weight of the mobile product, the suction cup 10 is automatically returned upward under the magnetic force. Specifically, the magnetic return device includes an upper magnet 261 and a lower magnet 262. The upper magnet 261 and the lower magnet 262 are vertically spaced apart from each other and disposed on the mounting portion. The suction cup 10 is provided with a magnetic member 15. The magnetic attraction force of the upper magnet 261 to the magnetic member 15 is greater than the magnetic attraction force of the lower magnet 262 to the magnetic member 15. When the suction cup 10 is moved downward, the magnetic member 15 is detached from the upper magnet 261 to be moved downward until it is attracted to the lower magnet 262. When the mobile product is taken out to offset part or all of the weight of the mobile product, the suction cup 10 is automatically returned upward and the magnetic member 15 is attracted to the upper magnet 261 under the magnetic attraction force of the upper magnet 261.

In the first embodiment, the periphery of the suction cup has a fully open design, which is suitable for suctioning and positioning mobile products of different sizes.

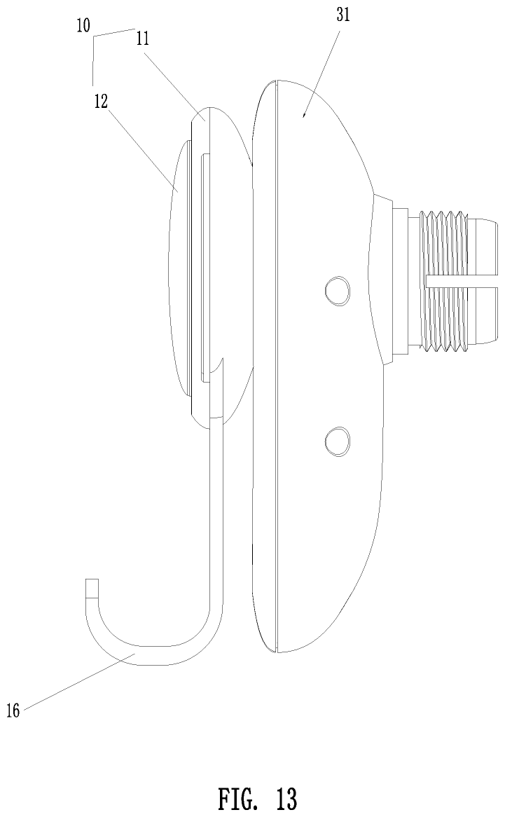

As shown in FIG. 13, the lower end of the suction cup 10 is provided with a bracket 16 for supporting the mobile product to prevent the mobile product from falling Of course, the suction cup holder with the bracket 16 can still be used for suctioning and positioning mobile products of different sizes.

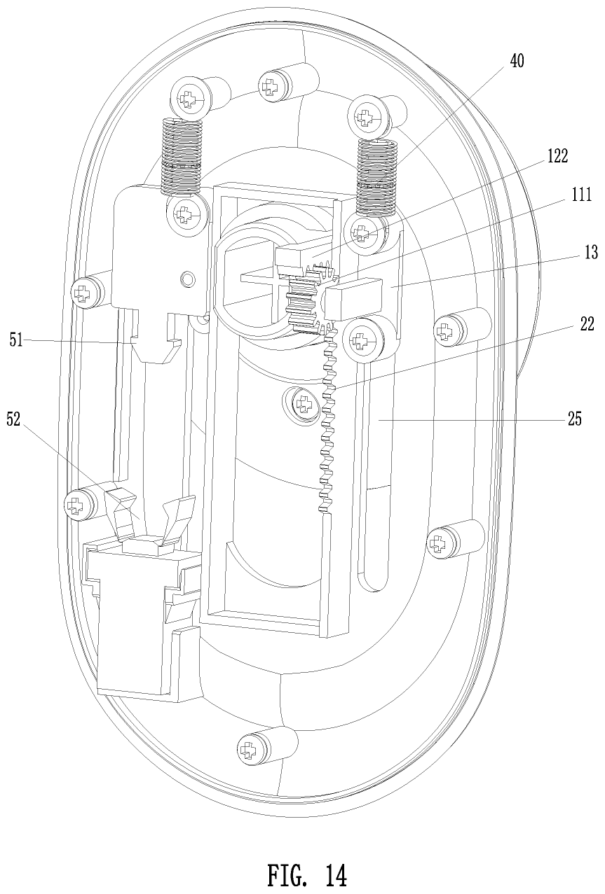

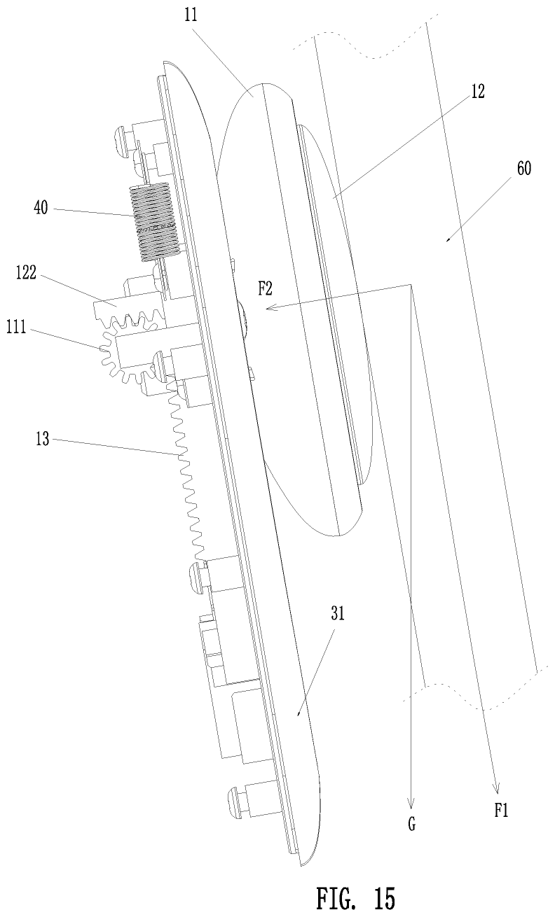

As shown in FIG. 14 and FIG. 15, a second exemplary implementation of the linking structure for the suction cup 10 to link the deformable suction panel 12 is shown.

The mounting portion has a first gear rack 22 extending vertically. The disk body 11 is connected with a gear 111. The axial direction of the gear 111 is in the lateral direction. The deformable suction plate 12 is connected with a second gear rack 22 extending back and forth. The first gear rack 22 and the second gear rack 122 are respectively meshed with the gear 111.

When the suction cup 10 is moved downward, the gear 111 is rotated clockwise along the first gear rack 22 while the second gear rack 122 is moved backward to pull the deformable suction panel 12 backward to be deformed. When the suction cup 10 is moved upward, the gear 111 is counterclockwise rotated along the first gear rack 22 while the second gear rack 122 is moved forward to gradually release the deformable suction panel 12 to be returned forward.

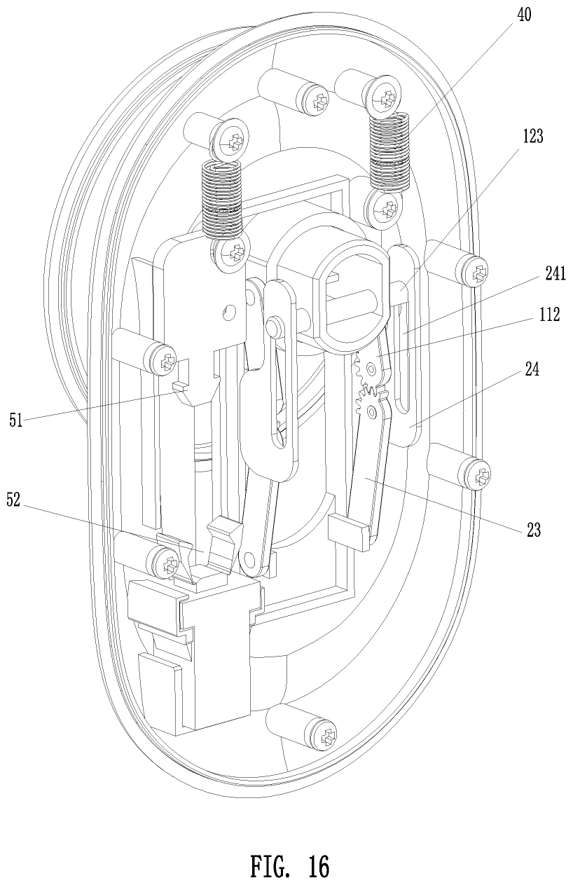

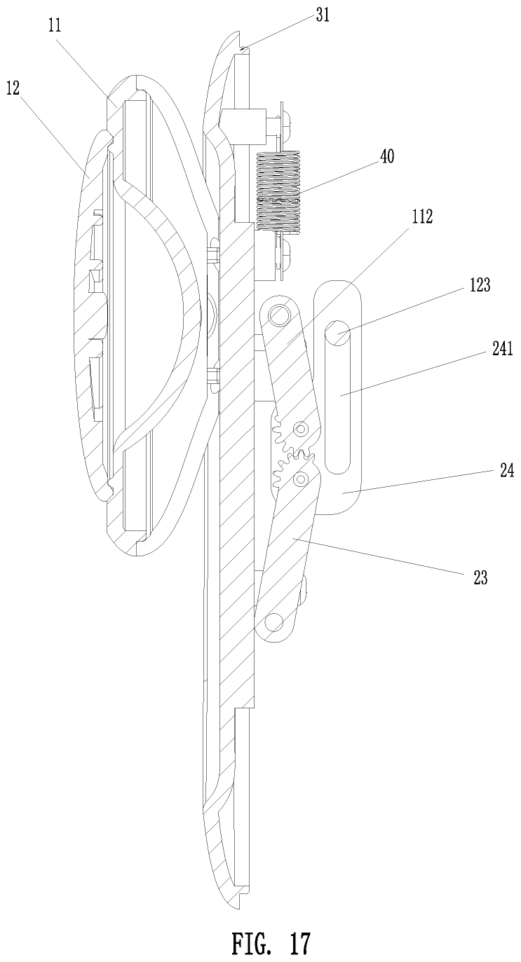

As shown in FIG. 16 and FIG. 17, a third exemplary implementation of the linking structure for the suction cup 10 to link the deformable suction panel 12 is shown.

The mounting portion has a first pivot rod 23. The lower end of the first pivot rod 23 is pivotally connected to the mounting portion. The disk body 11 is pivotally connected with a second pivot rod 112. The upper end of the second pivot rod 112 is pivotally connected to the disk body 11. The deformable suction panel 12 is connected with a second action portion 123.

The linking structure further includes a linking plate 24. The upper end of the first pivot rod 23 is pivotally connected to the linking plate 24. The lower end of the second pivot rod 112 is pivotally connected to the linking plate 24. The upper end of the first pivot rod 23 and the lower end of the second pivot rod 112 are formed with toothed portions to mesh with each other. The linking plate 24 is formed with a linking groove 241. The second action portion 123 is insertedly connected to the linking groove 241.

When the suction cup 10 is moved downward, the second pivot rod 112 is turned backward while the disk body 11 is moved downward, and the upper end of the first pivot rod 23 links the second pivot rod 112 to turn backward, so that the linking plate 24 is moved backward, and the second action portion 123 is linked to move backward to pull the deformable suction panel 12 backward to be deformed.

When the suction cup 10 is moved upward, the second pivot rod 112 is turned forward while the disk body 11 is moved upward, and the upper end of the first pivot rod 23 links the second pivot rod 112 to turn forward, so that the linking plate 24 is moved forward, and the second action portion 123 is linked to move forward to gradually release the deformable suction panel 12 to be returned forward.

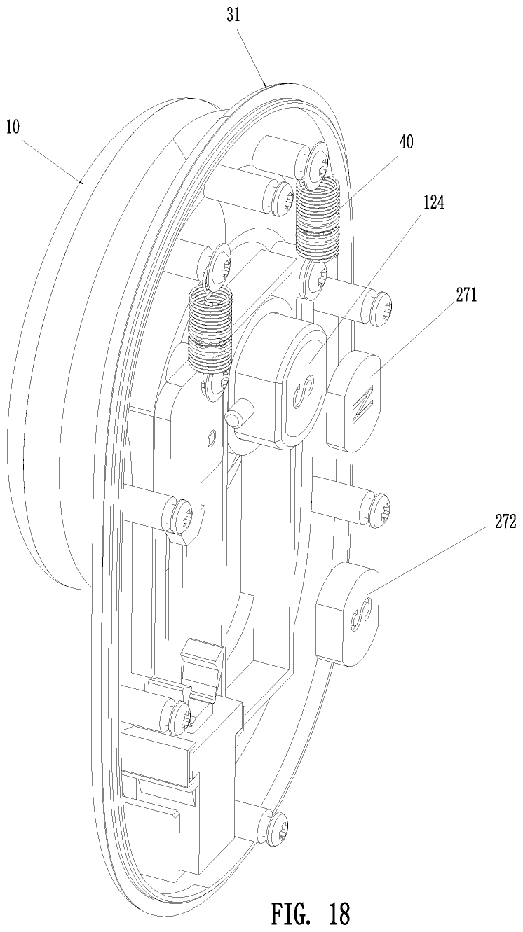

As shown in FIG. 18, a fourth exemplary implementation of the linking structure for the suction cup 10 to link the deformable suction panel 12 is shown.

The mounting portion is provided with a first magnet 271 and a second magnet 272 that are vertically spaced apart from each other. The deformable suction panel 12 is connected with a third magnet 124. The third magnet 124 and the first magnet 271 have opposite poles. The third magnet 124 and the second magnet 272 have like poles. In the initial state, the third magnet 124 is located above the front side of the first magnet 271.

As shown in FIG. 15, the deformable suction panel 12 leans backward to form an oblique placement surface for the mobile product to be placed obliquely. When the mobile product 60 is placed obliquely on the placement surface, the gravity G of the mobile product 60 is resolved into a downward slide force F1 in the oblique direction and a press force F2 against the suction cup 10 backward. The downward slide force F1 causes the suction cup 10 to be moved obliquely downward. When the suction cup 10 is moved downward, the deformable suction panel 12 is linked to be deformed backward until the mobile product is suctioned and positioned tightly. In the process of suctioning and positioning the mobile product, the suction cup is always kept downward by the gravity of the mobile product, ensuring that the mobile product is suctioned by the suction cup tightly.

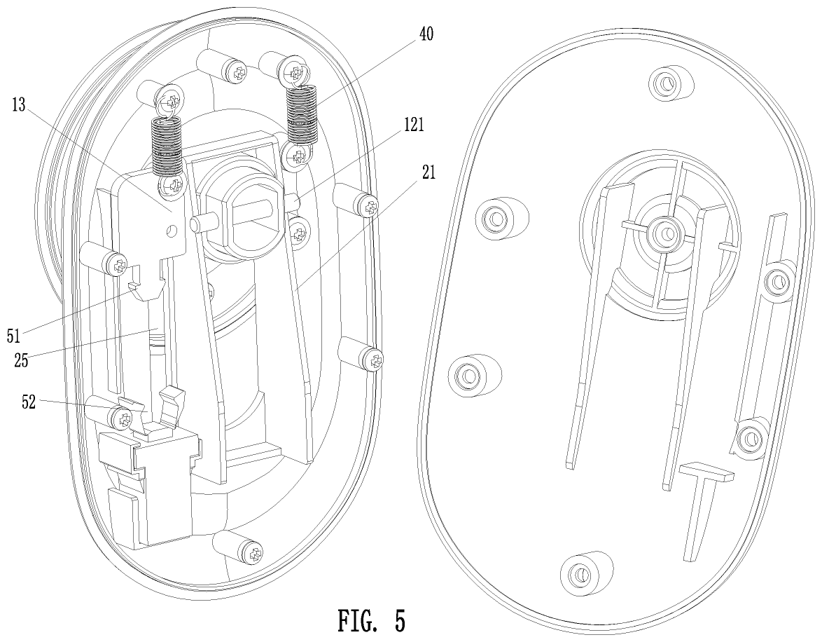

As shown in FIG. 5, the suction cup 10 is provided with a self-locking mechanism. When the suction cup 10 is moved downward, the self-locking mechanism limits the suction cup 10 to be at the lowest position. When the mobile product is taken out, the suction cup 10 is disengaged from the self-locking mechanism to be moved upward. In the first embodiment, the self-locking mechanism includes an engaging protrusion 51 and an engaging groove 52. The engaging protrusion may be in the form of a hook or an elastic piece. The engaging protrusion 51 is detachably engaged with the engaging groove 52. One of which is disposed on the suction cup 10, and the other is disposed on the mounting portion. Of course, the self-locking mechanism may be a magnetic self-locking mechanism, including a locking magnet and a locking magnetic member. The locking magnet and the locking magnetic member are detachably attracted to each other. One of which is disposed on the suction cup 10, and the other is disposed on the mounting portion.

Generally, the suction cup holder is provided with a return device to unlock the self-locking mechanism. If the return device is provided, it is necessary to push the self-locking mechanism upward so as to unlock the self-locking mechanism.

The suction cup holder may have a wireless charging function. For example, a wireless charging unit is disposed in the housing 31, so that when a mobile electronic product, such as a mobile phone, is suctioned and positioned on the suction cup 10, wireless charging can be performed as needed.

It should be noted that the feature of the present invention is that the upward and downward movement of the suction cup is associated with the deformation of the deformable suction panel, with the help of the gravity of the placed mobile product to act on the suction cup to move down. Therefore, although the present invention has several specific structural designs of various embodiments, each has its own unique ingenuity. The application of the technical solution of the present invention is not limited to the illustrated embodiments.

For example, one of the above-mentioned various linking structures may be selected for the actual design and manufacture of the suction cup holder, or other linking structures other than the four linking structures may be adopted.

For the specific designs of the mounting body, the guide groove, the shielding sheet, the return device, the self-locking mechanism, the wireless charging unit and the deformable suction plate to be arranged obliquely or vertically, in the actual design and production, these designs may be not adopted, or one, or two or a combination thereof is adopted.

The suction cup 10, in the foregoing embodiments, mainly includes the disk body 11 and the deformable suction panel 12. Generally, the deformable suction panel 12 is preferably designed to be a convex spherical crown surface. A handle is connected to the inner side of the deformable suction panel 12. One end of the handle is connected to the inner side of the deformable suction panel 12. For example, one end of the handle is embedded in the inner side of the deformable suction panel 12 through a barb and a groove, or one end of the handle is bonded and fixed to the inner side of the deformable suction panel 12. The disk body 11 has a mounting hole. The other end of the handle serves as an insertion portion to pass through the mounting hole. The insert portion is moveably disposed in the extending direction of the mounting hole for pulling the deformable suction panel 12 to be deformed. The inner circumference of the deformable suction panel 12 is provided with a first protruding ring. An annular groove and a second protruding ring are disposed on the outer side of the disk body 11. The first protruding ring is fitted in the annular groove and surrounds the periphery of the second protruding ring. The inner side of the deformable suction panel 12 may be provided with another annular groove corresponding to the inside of the first protruding ring for the second protruding ring to be fitted therein. In this way, multiple curved sealing contacts are formed to ensure the positioning effect and the sealing effect.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A suction cup holder, comprising a suction cup and a mounting portion for mounting the suction cup; the suction cup having a disk body and a deformable suction panel disposed on one side of the disk body; the suction cup being moveable relative to the mounting portion, the deformable suction panel being deformable relative to the disk body; wherein when the suction cup is moved from a first position to a second position relative to the mounting portion, the deformable suction panel is linked to be deformed inward to increase the volume of a space between a mobile product and the deformable suction panel to form a negative pressure; wherein when the suction cup is moved from the second position to the first position relative to the mounting portion, the deformable suction panel is linked to be returned outward to reduce the volume of the space between the mobile product and the deformable suction panel.

2. The suction cup holder as claimed in claim 1, wherein the suction cup is disposed laterally or vertically or obliquely.

3. The suction cup holder as claimed in claim 1, wherein the deformable suction panel is disposed on a front side of the disk body, the suction cup is moved up and down relative to the mounting portion, the deformable suction panel is deformed back and forth relative to the disk body; when the suction cup is moved downward, the deformable suction panel is linked to be deformed backward to increase the volume of the space between the mobile product and the deformable suction panel to form the negative pressure; when the suction cup is moved upward, the deformable suction panel is linked to be returned forward to reduce the volume of the space between the mobile product and the deformable suction panel.

4. The suction cup holder as claimed in claim 1, wherein when the disk body is moved, the entire suction cup is driven to move, a linking structure is provided between the disk body and the deformable suction panel, so that the deformable suction panel is linked by the linking structure to be deformed or returned when the disk body is moved.

5. The suction cup holder as claimed in claim 4, wherein the linking structure includes a linking surface and a first action portion; the linking surface is disposed on the mounting portion, the linking surface extends from top to bottom and leans backward or the linking surface extends from the top to the bottom and curves backward; the deformable suction panel is connected to the first action portion, the first action portion is confined by a rear side of the linking surface and is selectively moved up and down along the linking surface;
when the suction cup is moved downward, the first action portion is moved downward along the linking surface to pull the deformable suction panel to be deformed backward; when the suction cup is moved upward, the first acting portion is moved upward along the linking surface to gradually release the deformable suction panel to be returned forward.

6. The suction cup holder as claimed in claim 4, wherein the linking structure includes a first gear rack, a second gear rack, and a gear; the first gear rack extends vertically and is disposed on the mounting portion, the disk body is connected to the gear, the second gear rack extends back and forth and is connected to the deformable suction panel; the gear is rotationally moved along the first gear rack to link the second gear rack to move back and forth;
when the suction cup is moved downward, the gear is rotated clockwise along the first gear rack while the second gear rack is moved backward to pull the deformable suction panel backward to be deformed; when the suction cup is moved upward, the gear is counterclockwise rotated along the first gear rack while the second gear rack is moved forward to gradually release the deformable suction panel to be returned forward.

7. The suction cup holder as claimed in claim 4, wherein the linking structure includes a first pivot rod, a second pivot rod, and a linking plate; a lower end of the first pivot rod is pivotally connected to the mounting portion, an upper end of the second pivot rod is pivotally connected to the disk body; an upper end of the first pivot rod is pivotally connected to the linking plate, a lower end of the second pivot rod is pivotally connected to the linking plate, the linking plate is connected to or acts on the deformable suction panel;
when the suction cup is moved downward, the second pivot rod is turned backward while the disk body is moved downward, and the upper end of the first pivot rod links the second pivot rod to turn backward, so that the linking plate is moved backward to link the deformable suction panel to be deformed backward;
when the suction cup is moved upward, the second pivot rod is turned forward while the disk body is moved upward, and the upper end of the first pivot rod links the second pivot rod to turn forward, so that the linking plate is moved forward to link the deformable suction panel to be returned forward.

8. The suction cup holder as claimed in claim 7, wherein the deformable suction panel is connected with a second action portion; the linking plate is formed with a linking groove, the second action portion is insertedly connected to the linking groove.

9. The suction cup holder as claimed in claim 7, wherein the upper end of the first pivot rod and the lower end of the second pivot rod are formed with toothed portions to mesh with each other.

10. The suction cup holder as claimed in claim 4, wherein the mounting portion is provided with a first magnet and a second magnet that are vertically spaced apart from each other, the deformable suction panel is connected with a third magnet; the third magnet and the first magnet have opposite poles; the third magnet and the second magnet have like poles; in an initial state, the third magnet is located above a front side of the first magnet.

11. The suction cup holder as claimed in claim 1, wherein the deformable suction panel leans backward to form an oblique placement surface for the mobile product to be placed obliquely; when the mobile product is placed obliquely on the placement surface, the mobile product's own gravity is resolved into a downward slide force in an oblique direction and a press force against the suction cup backward; the downward slide force causes the suction cup to be moved obliquely downward.

12. The suction cup holder as claimed in claim 1, wherein the mounting portion is provided with a guide groove extending vertically, the suction cup has a guide block, the guide block is slidably disposed in the guide groove;
the guide groove is exposed; or, a shielding plate is disposed on a front side of the guide groove, the shielding plate is connected to the suction cup to be moved up and down along with the suction cup relative to the mounting portion.

13. The suction cup holder as claimed in claim 1, further comprising a return device; the return device acts between the suction cup and the mounting portion; the return device automatically returns the suction cup upward when the mobile product is taken out to offset part or all of the weight of the mobile product.

14. The suction cup holder as claimed in claim 13, wherein the return device is an elastic return device or a magnetic return device.

15. The suction cup holder as claimed in claim 1, wherein the mounting portion has a housing and a mounting body, the suction cup is mounted on a front side of the housing, the housing is mounted on the mounting body; the suction cup is moved up and down relative to the housing; or, the suction cup and the housing are moved up and down together relative to the mounting body.

16. The suction cup holder as claimed in claim 1, wherein a lower end of the suction cup is provided with a bracket for supporting the mobile product.

17. The suction cup holder as claimed in claim 1, wherein the suction cup is provided with a self-locking mechanism; when the suction cup is moved downward, the self-locking mechanism limits the suction cup to be at a lowest position; when the mobile product is taken out, the suction cup is disengaged from the self-locking mechanism to be moved upward.

18. The suction cup holder as claimed in claim 17, wherein the self-locking mechanism includes an engaging protrusion and an engaging groove; the engaging protrusion is detachably engaged with the engaging groove, one of the engaging protrusion and the engaging groove is disposed on the suction cup, the other of the engaging protrusion and the engaging groove is disposed on the mounting portion;
or, the self-locking mechanism includes a locking magnet and a locking magnetic member, the locking magnet and the locking magnetic member are detachably attracted to each other, one of the locking magnet and the locking magnetic member is disposed on the suction cup, and the other of the locking magnet and the locking magnetic member is disposed on the mounting portion.

19. The suction cup holder as claimed in claim 1, wherein the disk body has a mounting hole, a rear end of the deformable suction panel is provided with an insertion portion to pass through the mounting hole, the insert portion is moveably disposed in the mounting hole for pulling the deformable suction panel to be deformed.

20. A method of suctioning and positioning a mobile product, comprising: when the mobile product is placed, a suction cup being moved from a first position to a second position and a deformable suction panel being linked to be deformed inward to increase the volume of a space between the mobile product and the deformable suction panel to form a negative pressure; when the mobile product is taken out, the suction cup being moved from the second position to the first position and the deformable suction panel is linked to be returned outward to reduce the volume of the space between the mobile product and the deformable suction panel.

21. The method as claimed in claim 20, wherein when the mobile product is placed, a downward force is exerted on the suction cup so that the suction cup is moved downward, and the deformable suction panel on the suction cup is linked to be deformed backward to increase the volume of the space between the mobile product and the deformable suction panel to form the negative pressure, and the mobile product is suctioned on a front side of the suction cup; the downward force acting on the suction cup comes from the mobile product's own gravity or a press force when the mobile product is placed or the sum of the mobile product's own gravity and the press force when the product is placed;
when the mobile product is taken out, the suction cup is moved upward by an upward force, and the deformable suction panel on the suction cup is linked to be returned forward to reduce the volume of the space between the mobile product and the deformable suction panel and increase the pressure of the space so that the mobile product can be taken out; the upward force comes from a first resultant force after a return force of a return device of the suction cup is offset by the mobile product's gravity or a second resultant force of the first resultant force and an upward push or the upward push.
